(19) United States
(12) Patent Application Publication
(10) Pub. No.: US 2026/0121847 A1
(43) Pub. Date: Apr. 30, 2026

(54) INFORMATION PROCESSING SYSTEM WITH INFORMATION SECURITY PROTECTION AND ARTIFICIAL INTELLIGENCE

(71) Applicant: ELGENS CO., LTD, New Taipei City (TW)

(72) Inventor: Chin-Chu LI, New Taipei City (TW)

(21) Appl. No.: 18/963,790

(22) Filed: Nov. 29, 2024

(30) Foreign Application Priority Data
Oct. 25, 2024 (TW) 113140853

(51) Int. Cl. H04L 9/08

(52) U.S. Cl. CPC H04L 9/088

(57) ABSTRACT

An information processing system includes a carrier board, a CPU module, a GPU module, an FPGA. The carrier board is connected to a middleware module and an API by information. The CPU module and the GPU module are connected to the carrier board. The FPGA is connected to the carrier board, the CPU module, and the GPU module. Accordingly, the CPU module can be easily replaced thereby saving time and costs. The FPGA, the CPU module, and the GPU module are jointly used to collaboratively analyze and process data thereby quickly acquiring correct data. The FPGA is used to perform the AI processing thereby effectively reducing the computing burden of the CPU module. A plurality of information security modules are used to receive several encrypted data, and the several encrypted data are combined to generate a private key, thereby achieving the effect of information security protection.

### TECHNICAL FIELD OF THE INVENTION

The present disclosure relates to an information processing system, and more particularly to an information processing system with information security protection and artificial intelligence.

### DESCRIPTION OF RELATED ART

The statements in this section merely provide background information related to the present disclosure and do not necessarily constitute prior art.

When military computers such as panel PCs are upgraded by replacing the CPU module, the computer needs to be replaced with a new heat dissipation case, and further the entire system structure of the computer also needs to be changed, which increases the development time and the development and verification costs.

Moreover, military computers not only need a CPU (central processing unit) chip, but also need to be equipped with an additional GPU (graphic processing unit) chip for 4K display to provide a smoother and clearer display so that images of temperature, altitude, wind direction, and humidity from 50 kilometers away can be displayed in real time. Sometimes multiple monitors are even required so that the war information command center can have more data to assess the situation from 50 kilometers away to avoid the possibility of misassessment. Therefore, the computing burden of the CPU chip is extremely heavy, thereby resulting in the inability to quickly acquire correct data.

The CPU chip is responsible for controlling the connectors of the entire system, such as LAN, HDMI, GPIO, Analogue IO, COM Express, to transmit high-speed signals, calculate and distribute the acquired data. Once an AI (artificial intelligence) algorithm is embedded in the CPU chip, the CPU will easily lose the real-time transmission of the I/O signals from the carrier board. Therefore, whether an artificial intelligence (AI) should be performed by the CPU chip has a big impact. In particular, according to the inventor's development and testing, a FPGA can be equipped in the carrier board, and the FPGA is specifically responsible for AI data processing, and therefore it will not reduce the computing performance of the CPU chip.

In addition, there is also an important issue of whether to use the CPU chip or the GPU chip to connect to the external LCD module. In order to select the computing capability of the CPU chip or GPU chip for display, and to enable the external LCD module to achieve higher resolution applications, a signal switching IC bridge chip must be added. This bridge chip must be able to carry strong high-speed signals so that there are no obstacles to high-speed communication between the CPU chip and the GPU chip. However, the manufacturing cost of developing this additional bridge chip is high, which also increases the area of the carrier board and becomes another heat source.

Military computers must meet the requirements of various countries'military regulations, such as the CMMC (cybersecurity maturity model certification) information security maturity model verification promoted by the U.S. Department of Defense to enhance the security of the system, thereby preventing the system from being tampered with by enemies or hackers, and even preventing the security and calculation of the algorithm from being affected. Accordingly, military computers must have strict information security protection mechanisms.

### SUMMARY OF THE INVENTION

An objective of the present disclosure is to provide an information processing system with information security protection and artificial intelligence. The information processing system with information security protection and artificial intelligence includes a carrier board, a central processing unit (CPU) module, a graphic processing unit (GPU) module, and a field programmable gate array (FPGA). The carrier board is connected to a middleware module and an application programming interface (API) by information, and the API performs interaction and communication between applications. The CPU module is movably connected to the carrier board by information. The GPU module is movably connected to the carrier board by information. The FPGA is connected the carrier board, the CPU module, and the GPU module by information, and the FPGA includes an artificial intelligence (AI) module and a switching module.

The AI module receives information transmitted by the CPU module and the GPU module, and performs AI information processing on the information. The CPU module and the GPU module are connected to a display, and the switching module selects the CPU module or the GPU module to transmit the information with the display according to computing capability of the CPU module and the GPU module.

Accordingly, the information processing system with information security protection and artificial intelligence has the following characteristics and advantages: 1. the movably connected CPU module can be easily replaced to easily upgrade the system without changing the structure of the system, thereby saving development time, development costs, and verification costs; 2. the FPGA, the CPU module, and the GPU module are jointly used to collaboratively analyze and process data, thereby quickly acquiring correct data and avoiding data misinterpretation; 3. the FPGA is used to perform the AI processing on the data, thereby effectively reducing the computing burden of the CPU module; 4. the FPGA can be used as a bridge chip between the CPU module and the GPU module; 5. a plurality of information security modules are used to receive several encrypted data, and the several encrypted data are combined to generate a private key, thereby achieving the effect of information security protection.

It is to be understood that both the foregoing general description and the following detailed description are exemplary, and are intended to provide further explanation of the present disclosure as claimed. Other advantages and features of the present disclosure will be apparent from the following description, drawings, and claims.

### BRIEF DESCRIPTION OF DRAWINGS

The present disclosure can be more fully understood by reading the following detailed description of the embodiment, with reference made to the accompanying drawing as follows:

FIG. 1 is a block diagram of an information processing system with information security protection and artificial intelligence according to the present disclosure.

FIG. 2 is a block diagram of an exemplified embodiment of an FPGA of the information processing system according to the present disclosure.

### DETAILED DESCRIPTION

Reference will now be made to the drawing figures to describe the present disclosure in detail. It will be understood that the drawing figures and exemplified embodiments of present disclosure are not limited to the details thereof.

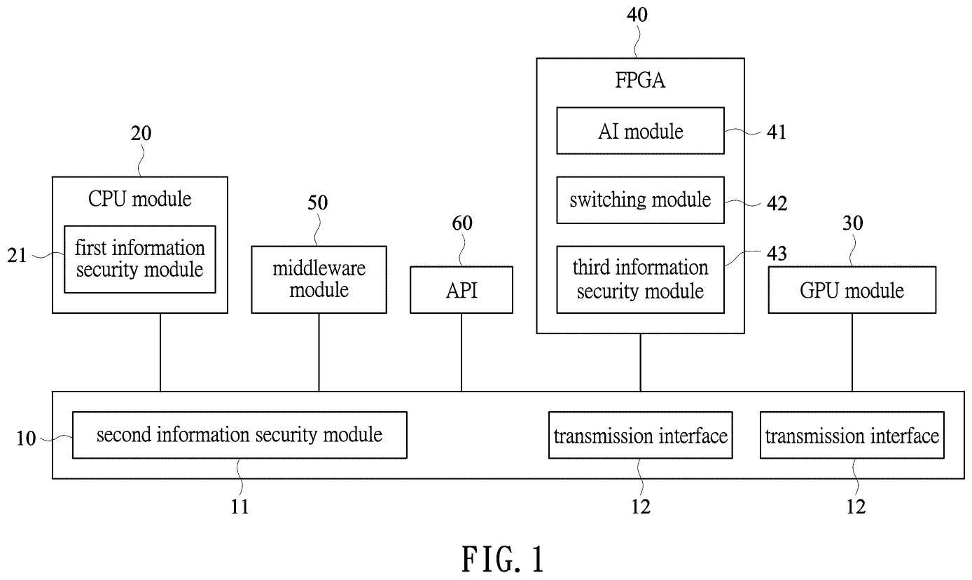

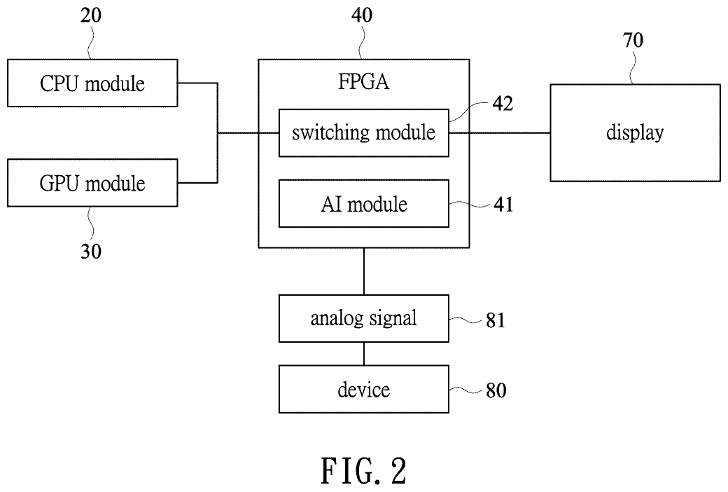

Please refer to FIG. 1, which shows a block diagram of an information processing system with information security protection and artificial intelligence according to the present disclosure, and please refer to FIG. 2, which shows a block diagram of an exemplified embodiment of a FPGA of the information processing system according to the present disclosure.

As shown in FIG. 1 and FIG. 2, the information processing system with information security protection and artificial intelligence includes a carrier board 10, a central processing unit (CPU) module 20, a graphic processing unit (GPU) module 30, and a field programmable gate array (FPGA) 40, and detailed descriptions will be explained as follows.

The carrier board 10 is connected to a middleware module 50 and an application programming interface (API) 60. The API 60 is used to perform interaction and communication between applications.

The CPU module 20 is movably connected to the carrier board 10 by information.

The GPU module 30 is movably connected to the carrier board 10 by information.

The FPGA 40 is connected to the carrier board 10, the CPU module 20, and the GPU module 30. The FPGA 40 includes an artificial intelligence (AI) module 41 and a switching module 42. The AI module 41 receives information transmitted by the CPU module 20 and the GPU module 30 and performs AI information processing on the information. The CPU module 20 and the GPU module 30 are connected to a display 70. The switching module 42 selects the CPU module 20 or the GPU module 30 to transmit the information with the display 70 according to computing capability of the CPU module 20 and the GPU module 30.

In one embodiment of the present disclosure, the middleware module 50 and the API 60 are connected to the FPGA 40, a first information security module 21, and a second information security module 11 by information. The first information security module 21 is installed in the CPU module 20 by information, and the second information security module 11 is installed in the carrier board 10. The first information security module 21 is used to receive a first encrypted datum (or data), and the second information security module 11 is used to receive a second encrypted datum (or data). The first encrypted datum and the second encrypted datum are combined by the middleware module 50 and the API 60 to generate a private key, and the private key is performed to decide whether the FPGA 40, the carrier board 10, and the CPU module 20 are activated.

In one embodiment of the present disclosure, the FPGA 40 further includes a third information security module 43. The third information security module 43 is used to receive a third encrypted datum (or data). The first encrypted datum, the second encrypted datum, and the third encrypted datum are combined by the middleware module 50 and the API 60 to generate a private key, and the private key is performed to decide whether the FPGA 40, the carrier board 10, and the CPU module 20 are activated.

In one embodiment of the present disclosure, a combination of the CPU module 20 and the carrier board 10 meets a computer-on-module high-performance computing (COM-HPC) specification or a computer-on-module (COM) Express specification.

In one embodiment of the present disclosure, the first information security module 21, the second information security module 11, and the third information security module 43 are selected from a trusted platform module (TPM).

The TPM is a dedicated security hardware module, which is used to increase the security of computer systems. The TPM is usually embedded on a motherboard of a computer or forms as a separate chip. It provides a secure environment for performing encryption operations, protecting sensitive data, and verifying system integrity. TPM has at least the following functions:
1. Generation and management of keys: the TPM can securely generate and store encryption keys that are not exposed to operation systems or applications.
2. Data encryption: the TPM can be used to encrypt and decrypt data to ensure only authorized users can access sensitive information.
3. Platform integrity verification: the TPM can verify the activation process of the system and the integrity of the software to ensure the system does not activate after unauthorized changes.
4. Digital signature: the TPM can be used to generate digital signatures to help verify the origin and integrity of data.
5. Remote authentication: the TPM supports remote authentication to allow external systems to verify the trusted status of the computer.
6. Tamper resistance: the TPM itself has a tamper-resistant design to ensure that its internal security operations will not be interfered by external attacks.

In one embodiment of the present disclosure, the carrier board 10 includes a plurality of transmission interfaces 12.

In one embodiment of the present disclosure, the transmission interface 12 is selected from a peripheral component interconnect express (PCI-E) specification or a PCI-E M.2 specification.

In one embodiment of the present disclosure, the GPU module 30 is selected from a mobile PCI express module (MXM) specification.

In one embodiment of the present disclosure, the FPGA 40 is connected to at least one device 80 by information, and the AI module 41 of the FPGA 40 receives, processes, and controls an analog signal 81 transmitted by at least one device 80, and converts the analog signal 81 into a digital signal.

After introducing the embodiments of the present disclosure, the features and effects of the present disclosure are disclosed as follows:

Overall, it has at least the following benefits:
1. The movably connected CPU module 20 can be easily replaced to easily upgrade the system without changing the structure of the system, thereby saving development time, development costs, and verification costs.
2. The FPGA 40, the CPU module 20, and the GPU module 30 are jointly used to collaboratively analyze and process data, thereby quickly acquiring correct data and avoiding data misinterpretation.
3. The FPGA 40 is used to perform the AI processing on the data, thereby effectively reducing the computing burden of the CPU module 20.
4. The FPGA 40 can be used as a bridge chip between the CPU module 20 and the GPU module 30, and its benefits are as follows:
a. Saving costs.
b. Saving the area of the carrier board 10.
c. Avoiding adding another chip and reducing heat sources.
d. The FPGA 40 is superior to other chips in terms of stability.
5. A plurality of information security modules are used to receive several encrypted data, and the several encrypted data are combined to generate a private key, thereby achieving the effect of information security protection, and its benefits are as follows:
a. The operation of the entire system is in compliance with the specifications of the US CMMC. The reason is that the present disclosure not only has the first information security module 21, the second information security module 11, and the third information security module 43 in hardware, but they can be driven by the middleware module 50, thereby providing the system information security protection.
b. The practical application of the present disclosure will allow it to enter the military supply chain of mainstream countries such as the United States, the United Kingdom, and France.
c. The FPGA 40 of the present disclosure can be equipped with the AI module 41. When this present disclosure provides customized services, after the customer develops the artificial intelligence algorithm, they can easily set up the artificial intelligence algorithm inside the AI module 41 in the FPGA 40. At the same time, the middleware module 50 of the present disclosure can help provide information security protection for the customer's algorithm.
d. The FPGA 40 of the present disclosure is used to bridge the CPU module 20 and the GPU module 30, which not only stabilizes the signal, but provides a computing platform for AI, and the FPGA 40 can be easily expanded to increase or expand the performance of the algorithm.
e. The GPU module 30 of the present disclosure allows the system to be independent of the computing capability of the computer, and displays the status of the external environment in real time, and at the same time allows the AI module 41 in the FGPA 40 to perform real-time analysis and sends the analysis results back to the war information command center through the network.
f. The entire system of the present disclosure is a modular structure, and the CPU module 20 and the GPU module 30 can be further simultaneously expanded without affecting the development progress of the entire system. Only system stability verification, such as MIL-STD-810H, needs to be performed.

Although the present disclosure has been described with reference to the preferred embodiments thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. An information processing system with information security protection and artificial intelligence, comprising:
a carrier board connected to a middleware module and an application programming interface (API) by information, and the API configured to perform interaction and communication between applications,
a central processing unit (CPU) module movably connected to the carrier board by information,
a graphic processing unit (GPU) module movably connected to the carrier board by information, and
a field programmable gate array (FPGA) connected the carrier board, the CPU module, and the GPU module by information, and the FPGA comprising an artificial intelligence (AI) module and a switching module; the AI module configured to receive information transmitted by the CPU module and the GPU module, and to perform an AI information processing on the information; the CPU module and the GPU module connected to a display, and the switching module configured to select the CPU module or the GPU module to transmit the information with the display according to computing capability of the CPU module and the GPU module.

2. The information processing system as claimed in claim 1, wherein the middleware module and the API are connected to the FPGA, a first information security module, and a second information security module by information; the first information security module installed in the CPU module by information, and the second information security module installed in the carrier board; the first information security module configured to receive a first encrypted datum, and the second information security module configured to receive a second encrypted datum; the first encrypted datum and the second encrypted datum combined by the middleware module and the API to generate a private key, and the private key is performed to decide whether the FPGA, the carrier board, and the CPU module are activated.

3. The information processing system as claimed in claim 2, wherein the FPGA further comprises a third information security module; the third information security module configured to receive a third encrypted datum; the first encrypted datum, the second encrypted datum, and the third encrypted datum combined by the middleware module and the API to generate a private key, and the private key is performed to decide whether the FPGA, the carrier board, and the CPU module are activated.

4. The information processing system as claimed in claim 1, wherein a combination of the CPU module and the carrier board meets a computer-on-module high-performance computing (COM-HPC) specification or a computer-on-module (COM) Express specification.

5. The information processing system as claimed in claim 3, wherein the first information security module, the second information security module, and the third information security module are selected from a trusted platform module (TPM).

6. The information processing system as claimed in claim 1, wherein the carrier board comprises a plurality of transmission interfaces.

7. The information processing system as claimed in claim 6, wherein the transmission interface is selected from a peripheral component interconnect express (PCI-E) specification or a PCI-E M.2 specification.

8. The information processing system as claimed in claim 1, wherein the GPU module is selected from a mobile PCI express module (MXM) specification.

9. The information processing system as claimed in claim 1, wherein the FPGA is connected to at least one device by information, and the AI module of the FPGA is configured to receive, process, and control an analog signal transmitted by at least one device, and convert the analog signal into a digital signal.
